(19) United States
(12) Patent Application Publication
(10) Pub. No.: US 2004/0052161 A1
(43) Pub. Date: Mar. 18, 2004

(54) Mechanical clock having wireless manipulation and adjustment function

(76) Inventor: Steven Liao, Taipei (TW)

Correspondence Address: BROWDY AND NEIMARK, P.L.L.C., 624 NINTH STREET, NW, SUITE 300, WASHINGTON, DC, 20001-5303, US

(21) Appl. No.: 10/244,716

(22) Filed: Sep. 17, 2002

(51) Int. Cl. G04C 11/02; G04C 9/00; G04B 27/00

(52) U.S. Cl. 368/47; 368/187; 368/185

(57) ABSTRACT

A mechanical clock having wireless manipulation and adjustment function includes a remote controller and a mechanical clock. The mechanical clock has a reception circuit board for receiving a wireless signal emitted by the remote controller to drive a motor to rotate. The motor then jointly leads a gear set to drive a hand of the mechanical clock to rotate. The remote controller can manipulate the alarm ring setting of the mechanical clock. The remote controller can be used to turn on or off the alarm ring timing function and the snooze function, and set the time of an alarm ring timing hand. A user can thus use the remote controller to manipulate related settings of the mechanical clock to facilitate the manipulations thereof.

### FIELD OF THE INVENTION

The present invention relates to a mechanical clock having wireless manipulation and adjustment function and, more particularly, to a mechanical clock, whose setting can be wirelessly adjusted using a remote controller to facilitate the manipulation thereof.

### BACKGROUND OF THE INVENTION

The utmost function of a common mechanical desk clock or wall clock is to provide accurate time display, or to further provide time-telling at exact hours and time-prompting by alarm ring. How to provide a prompt and accurate time is very important for users.

It is necessary for a user himself to adjust the alarm ring setting of a common desk clock or wall clock. An adjustment knob of an alarm ring timing hand is generally disposed at the back of the desk clock or wall clock. However, the distance between the user and the desk clock may be too large, or the wall clock may be hung high on the wall, resulting in trouble and inconvenience of the adjustment for the user.

Accordingly, the above conventional mechanical desk clock or wall clock has inconvenience and drawbacks in practical use. The present invention aims to propose a mechanical clock having wireless manipulation and adjustment function to resolve the problems in the prior art.

### SUMMARY OF THE INVENTION

The primary object of the present invention is to provide a mechanical clock having wireless manipulation and adjustment function so that a user can manipulate adjustments of the mechanical clock with a remote controller without directly adjusting the setting of a mechanical desk clock or wall clock, thereby facilitating adjustments of the mechanical clock.

To achieve the above object, the present invention provides a mechanical clock having wireless manipulation and adjustment function, which comprises a remote controller and a mechanical clock. The remote controller is used to emit a wireless signal. The mechanical clock has a reception circuit board, a motor, and a gear set. The reception circuit board receives the wireless signal emitted by the remote controller to drive the motor, which then jointly drives the gear set to lead a hand of the mechanical clock to rotate.

The various objects and advantages of the present invention will be more readily understood from the following detailed description when read in conjunction with the appended drawings, in which:

### BRIEF DESCRIPTION OF THE DRAWINGS:

FIG. 1 is a perspective view of the present invention;

FIG. 2 is an internal structure diagram of the present invention;

FIG. 3 is a circuit diagram of a remote controller of the present invention;

FIG. 4 is a circuit diagram of a reception circuit board of the present invention; and

FIG. 5 is an operational flowchart of the present invention.

### DETAILED DESCRIPTION OF THE PREFERRED EMBODIMENTS

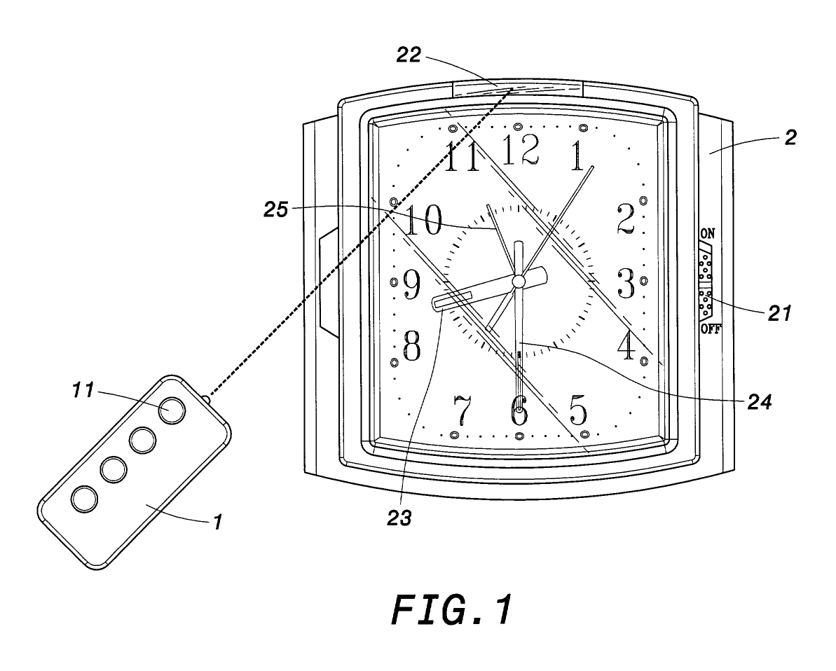

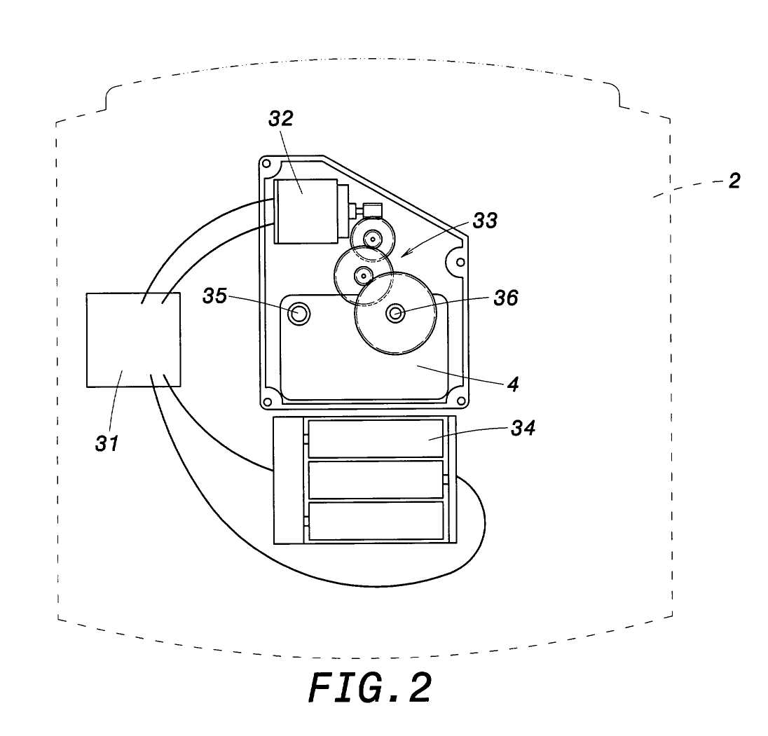

As shown in FIGS. 1 and 2, the present invention provides a mechanical clock having wireless manipulation and adjustment function, which uses a remote controller 1 to remotely control related settings (e.g., the alarm ring) of a mechanical clock 2. Several keys 11 are disposed on the remote controller 1. Pressing the keys 11 performs wireless signal instructions for the alarm ring switch setting, alarm ring time setting, and relayed alarm ring setting. The mechanical clock 2 shown in the figure is a desk clock (a wall clock is also feasible). Key switches 21 for setting alarm ring and a reception window 22 for receiving the signal of the remote controller 1 are disposed at the outside of the mechanical clock 2 (Other keys and knobs are not shown in the figure). A reception circuit board 31, a motor 32 connected to the reception circuit board 31, a gear set driven by the motor 32, and a battery set 34 providing power for the mechanical clock 2 are disposed in the mechanical clock 2. The gear set 33 is used to drive a hand (e.g., a hour hand 23, a minute hand 24, or an alarm ring timing hand 25) on the panel of the mechanical clock 2 to rotate. A time adjustment rod 35 for manually adjusting the hour hand 23 and the minute hand 24 and a timing hand adjustment rod 36 for adjusting the alarm ring time are disposed on the gear set 33.

After the remote controller 1 emits out a related wireless signal for adjusting the alarm ring, the reception circuit board 31 in the mechanical clock 2 receives the wireless signal and then drives the motor 32 to rotate. The motor 32 then jointly drives the timing hand adjustment rod 36 in the gear set 33 to lead the alarm ring timing hand 25 of the mechanical clock 2 to rotate, thereby achieving the object of wirelessly adjusting the alarm ring timing hand 25.

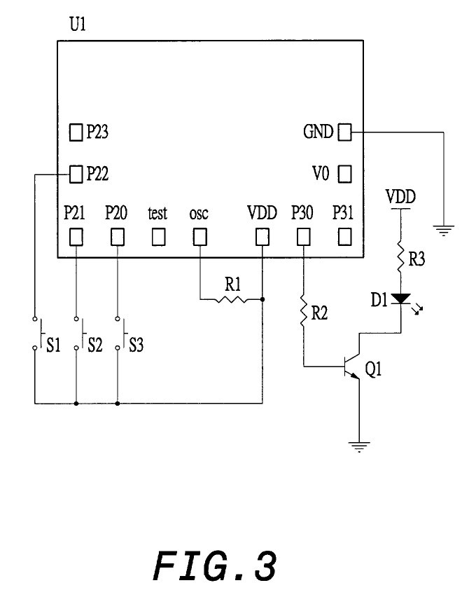

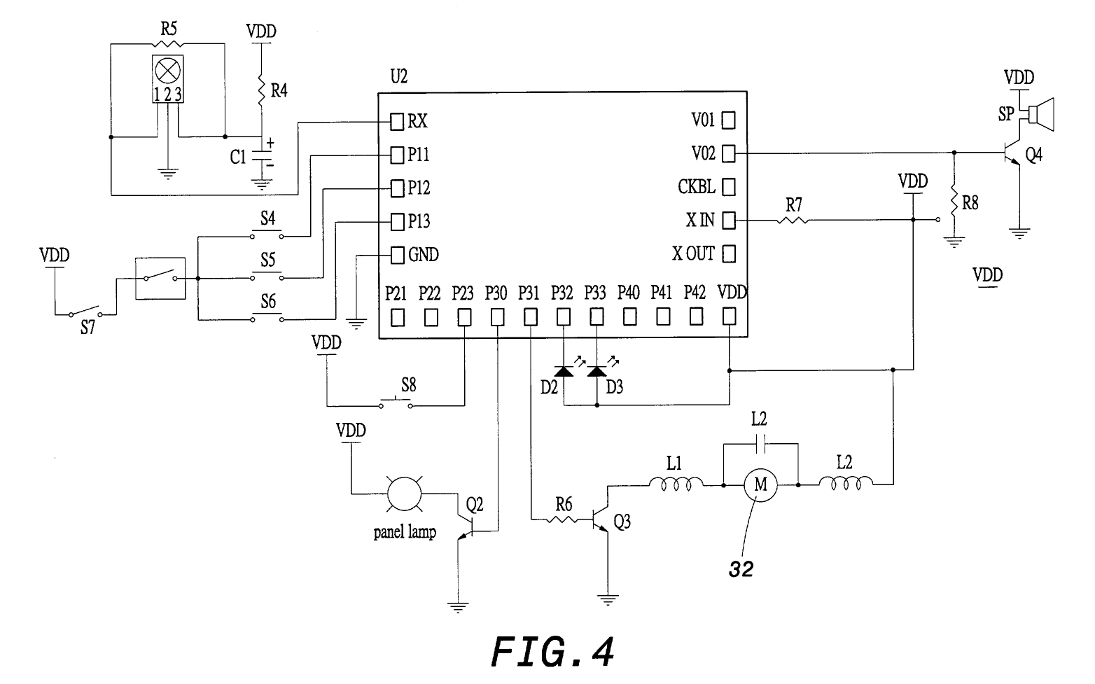

As shown in FIGS. 3 and 4, the remote controller 1 comprises a wireless emission chip U1, a plurality of keys S1 to S3, resistors R1 to R3, a transistor Q1, and a light-emitting diode D1. The reception circuit board 31 comprises a wireless reception chip U2, a plurality of resistors R4 to R8, transistors Q2 to Q3, and other components.

The functions of the keys S1 to S3 are for the alarm ring switch setting, alarm ring time setting, and snooze setting, respectively. The light-emitting diode D1 emits out an infrared wireless signal to be received by the wireless reception chip U2. Switches S4 to S7 are used to set time parameters of the alarm ring (e.g., the time interval of the alarm ring). A buzzer SP is used to give out alarm rings. A panel lamp is used to provide illumination for time display. An “ON” lamp D2 and an “OFF” lamp D3 are used to display the on and off states of the alarm ring switch, respectively.

When the keys S1 to S3 of the remote controller 1 are pressed, the wireless emission chip U1 emits out an instruction for the alarm ring switch setting, alarm ring time setting, or snooze setting. After the wireless reception chip U2 of the reception circuit board 31 receives the infrared signal emitted by the remote controller 1, it responds with corresponding actions (e.g., the alarm ring switch, alarm ring time, or snooze) according to the instruction.

In other words, after the reception circuit board 31 receives an instruction for the alarm ring switch setting, the alarm ring switch is turned on to start timing or the alarm ring switch is turned off to stop timing. Or after the reception circuit board 31 receives an instruction for the alarm ring time setting, the transistor Q3 drives the motor 32 to rotate so as to adjust the time setting of the alarm ring timing hand 36 through the gear set 33. Or after the reception circuit board 31 receives an instruction for the relayed alarm ring setting, the transistor Q2 drives the panel lamp of the mechanical clock 2 to illuminate for 5 seconds and then go out. The present alarm ring action is also halted for a period of time and then continued.

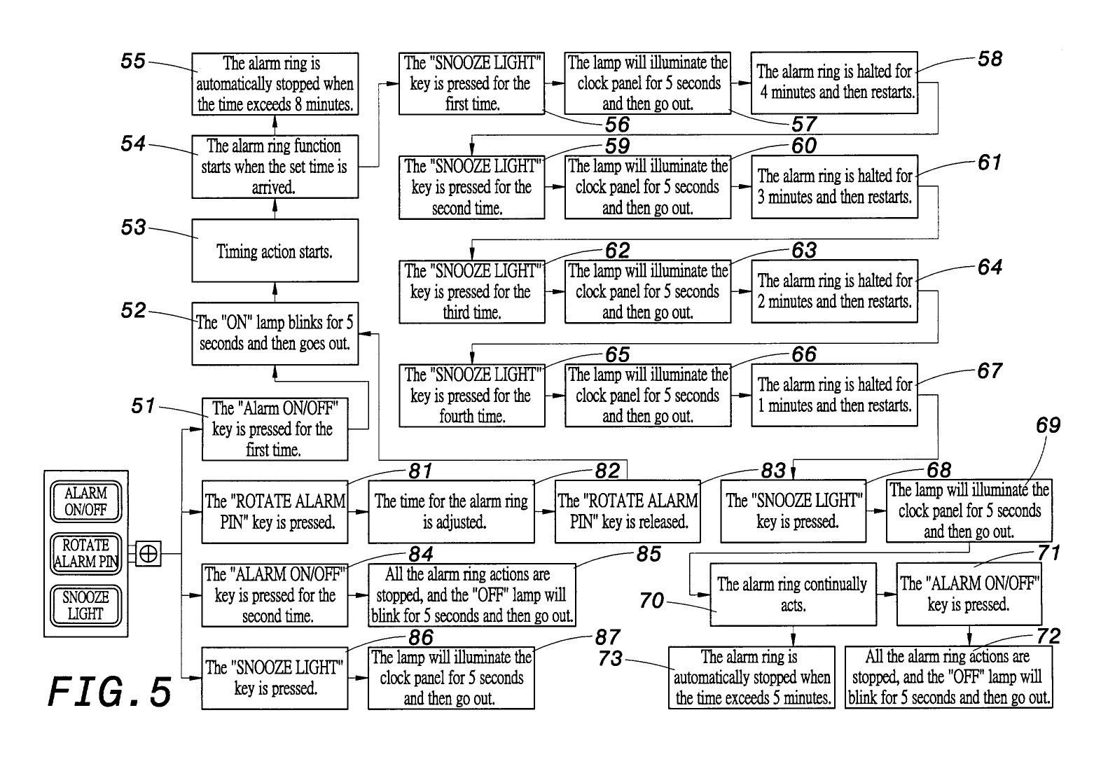

As shown in FIG. 5, the “ALARM ON/OFF” represents a key for the alarm ring switch, the “ROTATE ALARM PIN” represents a key for adjusting the alarm ring time, and the “SNOOZE LIGHT” represents a key for snoozing alarm ring. A user can uses the keys on the remote controller 1 to set the alarm ring of the mechanical clock 2. When the user presses the “ALARM ON/OFF” key for the first time (Step 51), the “ON” lamp will blink for 5 seconds and then go out (Step 52). The timing action of the alarm ring timing hand then starts (Step 53). The alarm ring function starts to give out alarm rings when the set time is arrived (Step 54). The alarm ring is automatically stopped when the time exceeds 8 minutes (Step 55). During the process of the alarm ring, if the user presses the “SNOOZE LIGHT” key (Step 56), the lamp will illuminate the clock panel for 5 seconds and then go out (Step 57). Next, the alarm ring is halted for 4 minutes and then restarts (Step 58). When the “SNOOZE LIGHT” key is pressed for the second time (Step 59), the lamp will illuminate the clock panel for 5 seconds and then go out (Step 60). The alarm ring is halted for 3 minutes and then restarts (Step 61). When the “SNOOZE LIGHT” key is pressed for the third time (Step 62), the lamp will illuminate the clock panel for 5 seconds and then go out (Step 63). The alarm ring is halted for 2 minutes and then restarts (Step 64). When the “SNOOZE LIGHT” key is pressed for the fourth time (Step 65), the lamp will illuminate the clock panel for 5 seconds and then go out (Step 66). The alarm ring is halted for 1 minutes and then restarts (Step 67). When the “SNOOZE LIGHT” key is pressed again (Step 68), the lamp will illuminate the clock panel for 5 seconds and then go out (Step 69). Subsequently, the alarm ring continually acts (Step 70). The “ALARM ON/OFF” key can be pressed to stop all the alarm ring actions (Step 71). The “OFF” lamp will then blink for 5 seconds and then go out (Step 72). Otherwise, the alarm ring is automatically stopped when the time exceeds 5 minutes (Step 73).

When the “ROTATE ALARM PIN” is pressed (Step 81), the time for alarm ring is adjusted (Step 82). After the “ROTATE ALARM PIN” key is released (Step 83), the “ON” lamp will blink for 5 seconds and then go out (Step 52).

When the “ALARM ON/OFF” key is pressed for the second time (Step 84), all the alarm ring actions are stopped, and the “OFF” lamp will blink for 5 seconds and then go out (Step 85).

When the “SNOOZE LIGHT” key is pressed (Step 86), the lamp will illuminate the clock panel for 5 seconds and then go out (Step 87).

To sum up, in the present invention, the conventional way of manually adjusting the clock is replaced with a wireless remote-control way to have better controllability. Users can thus quickly finish the manipulation and setting of wall clocks.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A mechanical clock having wireless manipulation and adjustment function, comprising:
a remote controller used to emit a wireless signal; and
a mechanical clock having a reception circuit board, a motor, and a gear set, said reception circuit board being used to receive said wireless signal emitted by said remote controller so as to drive said motor to rotate, said motor jointly leading said gear set to drive a hand of said mechanical clock to rotate.

2. The mechanical clock having wireless manipulation and adjustment function as claimed in claim 1, wherein said mechanical clock is one of a desk clock and a wall clock.

3. The mechanical clock having wireless manipulation and adjustment function as claimed in claim 1, wherein said remote controller has a plurality of keys, which are pressed to emit out said wireless signal.

4. The mechanical clock having wireless manipulation and adjustment function as claimed in claim 3, wherein said keys include an alarm ring switch key, an alarm ring time key, and a snooze key.

5. The mechanical clock having wireless manipulation and adjustment function as claimed in claim 1, wherein said wireless signal is an infrared signal emitted by a wireless emission chip.

6. The mechanical clock having wireless manipulation and adjustment function as claimed in claim 1, wherein said reception circuit board has a wireless reception chip for receiving said wireless signal emitted by said remote controller.

7. The mechanical clock having wireless manipulation and adjustment function as claimed in claim 1, wherein said hand is a timing hand for adjusting the alarm ring time.
